(19) United States
(12) Patent Application Publication
(10) Pub. No.: US 2026/0208574 A1
(43) Pub. Date: Jul. 23, 2026

(54) DRIVE ASSEMBLY FOR A MOTOR VEHICLE HAVING AN ELECTRIC MACHINE AND HAVING A LIQUID COOLING SYSTEM FOR COOLING THE ELECTRIC MACHINE

(71) Applicant: MAGNA Powertrain GmbH & Co KG, Lannach (AT)

(72) Inventor: Bernhard Steiner, Viehdorf (AT)

(21) Appl. No.: 19/137,707

(22) PCT Filed: Nov. 8, 2023
(86) PCT No.: PCT/EP2023/081111

§ 371 Date: Jun. 11, 2025

(30) Foreign Application Priority Data
Dec. 12, 2022 (DE) 10 2022 213 464.8

(51) Int. Cl. B60K 11/02; B60K 1/00; F16H 63/34; H02K 9/193

(52) U.S. Cl. CPC B60K 11/02; F16H 63/3416; H02K 9/193; B60K 2001/006

(57) ABSTRACT

A drive assembly for a motor vehicle including an electric machine has a parking lock assembly and a liquid cooling system for cooling the electric machine. The liquid cooling system has a mechanical coolant pump and a switchable bypass valve that can be actuated via an actuator of the parking lock assembly.

### CROSS-REFERENCE TO RELATED APPLICATIONS

This application is a National Stage of International Application No. PCT/EP2023/081111, filed Nov. 8, 2023, which claims priority to DE 10 2022 213 464.8, filed Dec. 12, 2022. The entire disclosures of each of the above applications are incorporated herein by reference.

### FIELD

The present disclosure relates to a drive assembly for a motor vehicle including an electric machine, a parking lock assembly, and a liquid cooling system for cooling the electric machine.

### BACKGROUND

This section provides a general summary of the disclosure, and is not a comprehensive disclosure of its full scope or all of its features.

In motor vehicles, electric machines which are operated as generators and/or motors are increasingly being used. Depending on the design and output, these electric machines need a specific cooling apparatus.

Numerous measures for cooling electric machines are known from the prior art, and there are differences between air cooling and liquid cooling, where liquid cooling is primarily used in power-intensive areas of use of the electric machine.

In liquid cooling, a forced coolant flow is generated by a coolant pump. Such a coolant pump can be operated mechanically or electrically. If a drive assembly including an electric machine and a liquid cooling system having an electric pump is compared with a drive assembly including an electric machine and a liquid cooling system having a mechanical pump, then the drive assembly having a liquid cooling system with mechanical pump has higher losses overall, since this necessarily runs together with a drive component or driven component of the drive assembly and cannot be operated independently of the remainder of the system.

Therefore, it is advantageous to use electric coolant pumps, which can be driven and controlled independently of a drive component or driven component of the drive assembly. A further advantage of these electric coolant pumps is that they can maintain a coolant flow even when the motor vehicle is switched off. However, when an electric coolant pump is used, the additional outlay on electrical and hydraulic installation and the considerable (additional) costs prove to be disadvantageous.

In motor vehicle drive assemblies having an internal combustion engine and automatic transmission and in motor vehicle drive assemblies having an electric machine (electric or hybrid drive), parking lock assemblies are also used, in order to rule out unintentional rolling away of the motor vehicle at any time and in any location.

### SUMMARY

This section provides a general summary of the disclosure, and is not a comprehensive disclosure of its full scope or all of its features.

The object of the present disclosure is to specify an improved drive assembly for a motor vehicle.

This object is addressed by the subject matter of the present disclosure and the various aspects and embodiments described herein.

The drive assembly according to the present disclosure for a motor vehicle includes an electric machine, a parking lock assembly, and a liquid cooling system for cooling the electric machine.

The liquid cooling system according to the present disclosure has a mechanical coolant pump and a switchable bypass valve.

According to the present disclosure, the bypass valve can be actuated via an actuator of the parking lock assembly.

In a preferred design variant of the present disclosure, the actuator of the parking lock assembly has a rotatable operating shaft. An actuator gear wheel is preferably arranged in a fixed location, i.e. co-rotationally and axially fixedly, on the operating shaft, wherein a slotted guide, via which the bypass valve can be actuated, is formed on the actuator gear wheel.

The bypass valve is preferably arranged on a pressure side of the mechanical coolant pump and, in an open position, opens a bypass coolant channel from the pressure side of the mechanical coolant pump to a coolant sump and thus to a suction side of the mechanical coolant pump.

The liquid cooling system preferably has a main coolant channel which, downstream of the mechanical coolant pump, leads to the electric machine, wherein the bypass coolant channel branches off from the main coolant channel and is hydraulically coupled to the main coolant channel, wherein the coolant channel cross section of the main coolant channel is, at least in some sections, smaller than the coolant channel cross section of the bypass coolant channel.

The parking lock assembly preferably has a parking lock, wherein the parking lock and the bypass valve can be actuated by the actuator as a unit, i.e. jointly, in three operating positions, namely in:
a first operating position, in which the parking lock is engaged and the bypass valve is closed,
a second operating position, in which the parking lock is disengaged and the bypass valve is closed, and
a third operating position, in which the parking lock is disengaged and the bypass valve is open.

By way of the design of the drive assembly according to the present disclosure, it is possible with a structure that is efficient in terms of component and installation space to ensure needs-based operation of a mechanical coolant pump. In such a way, a cost-optimized system is provided which, for example in a “WLTP” (“Worldwide Harmonized Light-Duty Vehicles Test Procedure”) cycle, has minimal losses and is no worse than a system with an electric pump.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

FIG. 1 shows a schematic illustration of a liquid cooling system with a closed bypass valve.

FIG. 2 shows a schematic illustration of a liquid cooling system with an open bypass valve.

FIG. 3 shows a perspective view of a parking lock assembly and a bypass valve.

FIG. 4 shows a schematic illustration of a bypass valve and an actuator gear wheel, wherein the bypass valve is closed.

### DETAILED DESCRIPTION

The drive assembly is suitable for use in a motor vehicle and includes an electric machine, a parking lock assembly 1, and a liquid cooling system 2 for cooling the electric machine.

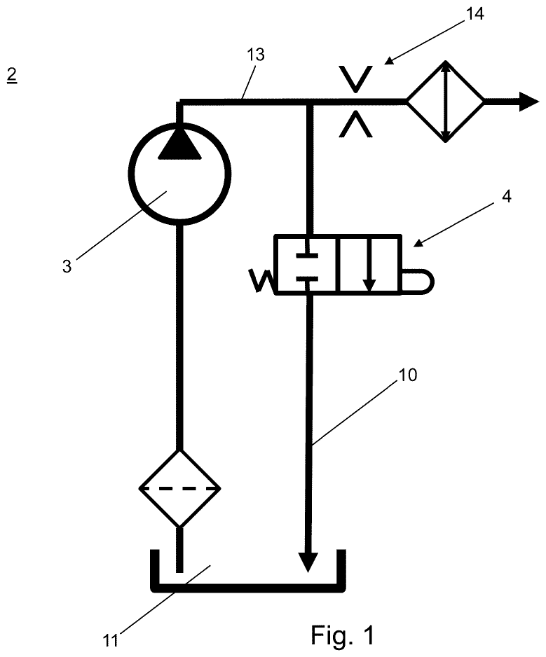

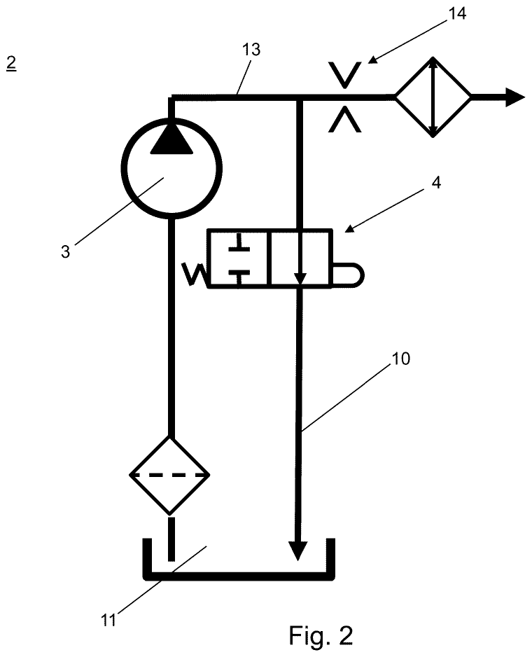

FIG. 1 and FIG. 2 each show a schematic illustration of the liquid cooling system 2. The liquid cooling system 2 has a coolant sump 11 with liquid coolant, a mechanical coolant pump 3, a switchable bypass valve 4, a main coolant channel 13, a bypass coolant channel 10, and a throttle 14.

The liquid coolant is an oil. However, it can also be any other desired liquid coolant suitable for use in a motor vehicle.

The mechanical coolant pump 3 has an inlet area and an outlet area. The inlet area of the mechanical coolant pump 3 forms a suction side 12 of the mechanical coolant pump 3, and the outlet area of the mechanical coolant pump 3 forms a pressure side 9 of the mechanical coolant pump 3.

The mechanical coolant pump 3 conveys liquid coolant from the coolant sump 11 from the suction side 12 to the pressure side 9 of the mechanical coolant pump 3.

The pressure side 9 of the mechanical coolant pump 3 is hydraulically coupled to a main coolant channel 13. Via the main coolant channel 13, liquid coolant can be conveyed to the electric machine in order to cool the latter or components of the electric machine that are to be cooled.

The bypass coolant channel 10 branches off the main coolant channel 13 downstream of the pressure side 9 of the mechanical coolant pump 3. The bypass coolant channel 10 is hydraulically coupled to the main coolant channel 13.

The switchable bypass valve 4 is arranged in the bypass coolant channel 10 and is designed to close the bypass coolant channel 10 in a first switching position (FIG. 1) and to open the bypass coolant channel 10 in a second switching position and thus permit the coolant flow of the liquid coolant through the bypass coolant channel 10 (FIG. 2).

The throttle 14 is arranged in the main coolant channel 13 downstream of the branch of the bypass coolant channel 10 from the main coolant channel 13 and permits a variation in the coolant channel cross section of the main coolant channel 13 as compared with the coolant channel cross section of the bypass coolant channel 10 via the throttle 14, the coolant channel cross section of the main coolant channel 13 can be reduced as compared with the coolant channel cross section of the bypass coolant channel 10.

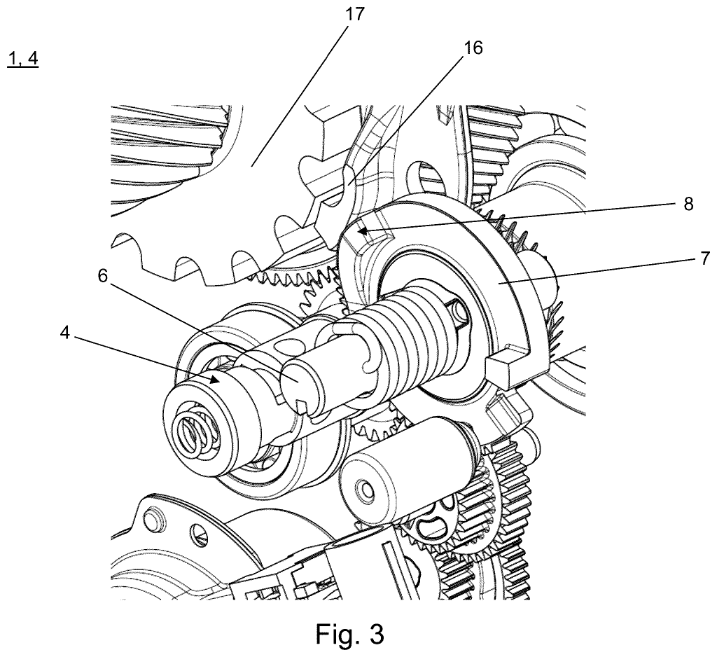

A perspective illustration of the parking lock assembly 1 and of the switchable bypass valve 4 is shown in FIG. 3. The parking lock assembly 1 has a parking lock 15 with a parking lock pawl 16 and a parking lock wheel 17. The parking lock 15 can be actuated via the actuator 5. Furthermore, the bypass valve 4 can be actuated via an actuator 5 of the parking lock assembly 1. The actuator 5 of the parking lock assembly 1 is thus used for the actuation of the parking lock 15 of the parking lock assembly 1 and for the actuation or switching of the bypass valve 4. By way of this multiple use of the actuator 5, amongst other things a structure that is efficient in terms of component and installation space and is cost-optimized can be achieved.

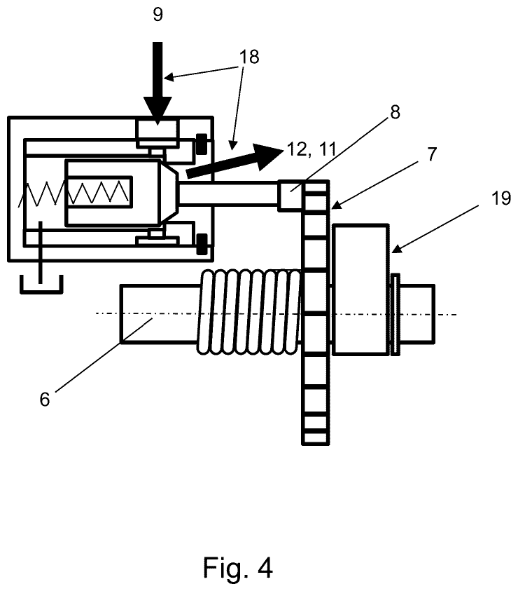

The actuator 5 of the parking lock assembly 1 has a rotatable operating shaft 6. An actuator gear wheel 7 is arranged in a fixed location, i.e. co-rotationally and axially fixedly, on the operating shaft 6. A slotted guide 8, via which the bypass valve 4 can be actuated and switched, is formed on the actuator gear wheel 7. FIG. 4 shows a schematic cross-sectional and lateral illustration of the switchable bypass valve 4 and of the actuator gear wheel 7 with slotted guide 8.

The parking lock 15 of the parking lock assembly 1 and the bypass valve 4 can be actuated by the actuator 5 of the parking lock assembly 1 as a unit, i.e. jointly, in three operating positions, namely in:
a first operating position, in which the parking lock 15 is engaged and the bypass valve is closed,
a second operating position, in which the parking lock 15 is disengaged and the bypass valve is closed, and
a third operating position, in which the parking lock 15 is disengaged and the bypass valve is open.

The parking lock pawl 16 of the parking lock 15 is actuated via a cam 19 which, like the actuator gear wheel 7, is arranged in a fixed location on the operating shaft 6 of the actuator 5 of the parking lock assembly 1 (FIG. 4).

If the bypass coolant channel 10 is closed via the bypass valve 4, all the liquid coolant conveyed via the coolant pump 3 is conveyed to the electric machine via the main coolant channel 13. The flow rate of liquid coolant can be controlled via the throttle 14 (FIG. 1, FIG. 4). In FIG. 4, the flow direction of the coolant when the bypass valve 4 is open, namely from the pressure side 9 to the suction side 12 of the mechanical coolant pump 3, is illustrated schematically by the directional arrows 18 on the closed bypass valve 4 that is illustrated. During this operation, the back pressure of the mechanical coolant pump 3 is at a minimum (zero in the best case), and the pump losses likewise go towards zero. As a result, lossless operation of the mechanical coolant pump 3 is achieved.

If the bypass coolant channel 10 is opened via the bypass valve 4 and the coolant channel cross section of the main coolant channel 13 is reduced via the throttle 14 as compared with the coolant channel cross section of the bypass coolant channel 10, then virtually all of the coolant conveyed via the coolant pump 3 is led back from the pressure side 9 of the mechanical coolant pump 3 into the coolant sump 11 and thus back to the suction side 12 of the mechanical coolant pump 3 (FIG. 2).

### LIST OF DESIGNATIONS

1 Parking lock assembly
2 Liquid cooling system
3 Mechanical coolant pump
4 Bypass valve
5 Actuator
6 Operating shaft
7 Actuator gear wheel
8 Slotted guide
9 Pressure side
10 Bypass coolant channel
11 Coolant sump
12 Suction side
13 Main coolant channel
14 Throttle
15 Parking lock
16 Parking lock pawl
17 Parking lock wheel
18 Directional arrow
19 Cam

What is claimed is:

1. A drive assembly for a motor vehicle, comprising
an electric machine,
a parking lock assembly and
a liquid cooling system for cooling the electric machine, wherein the liquid cooling system has a mechanical coolant pump and a switchable bypass valve wherein the bypass valve can be actuated via an actuator of the parking lock assembly.

2. The drive assembly as claimed in claim 1,
wherein the actuator of the parking lock assembly has a rotatable operating shaft wherein an actuator gear wheel fixed on the operating shaft wherein a slotted guide via which the bypass valve is actuated, is formed on the actuator gear wheel.

3. The drive assembly as claimed in claim 1,
wherein the bypass valve is arranged on a pressure side of the mechanical coolant pump and, in an open position, opens a bypass coolant channel from the pressure side of the mechanical coolant pump to a coolant sump and thus a suction side of the mechanical coolant pump.

4. The drive assembly as claimed in claim 1,
wherein the liquid cooling system has a main coolant channel which leads to the electric machine,
wherein a bypass coolant channel branches off the main coolant channel and is hydraulically coupled to the main coolant channel,
wherein a coolant channel cross section of the main coolant channel is, at least in some sections, smaller than the coolant channel cross section of the bypass coolant channel.

5. The drive assembly as claimed in claim 2,
wherein the parking lock assembly has a parking lock,
wherein the parking lock and the bypass valve are actuated via the actuator as a unit in three operating positions,
wherein the operating positions include:
a first operating position, in which the parking lock is engaged and the bypass valve is closed,
a second operating position, in which the parking lock is disengaged and the bypass valve is closed, and
a third operating position, in which the parking lock is disengaged and the bypass valve is open.

6. The drive assembly as claimed in claim 3,
wherein the liquid cooling system has a main coolant channel which leads to the electric machine,
wherein the bypass coolant channel branches off the main coolant channel and is hydraulically coupled to the main coolant channel,
wherein a coolant channel cross section of the main coolant channel is, at least in some sections, smaller than the coolant channel cross section of the bypass coolant channel.

7. The drive assembly as claimed in claim 6, wherein a throttle is disposed in the main cooling channel.

8. The drive assembly as claimed in claim 7, wherein the throttle disposed downstream of a branching location of the bypass cooling channel from the main cooling channel.

9. The drive assembly as claimed in claim 5, wherein the parking lock is actuated by a cam that is fixed on the operating shaft.

10. The drive assembly as claimed in claim 2,
wherein the bypass valve is arranged on a pressure side of the mechanical coolant pump and, in an open position, opens a bypass coolant channel from the pressure side of the mechanical coolant pump to a coolant sump and thus a suction side of the mechanical coolant pump.

11. The drive assembly as claimed in claim 10,
wherein the liquid cooling system has a main coolant channel which leads to the electric machine,
wherein the bypass coolant channel branches off the main coolant channel and is hydraulically coupled to the main coolant channel,
wherein a coolant channel cross section of the main coolant channel is, at least in some sections, smaller than a coolant channel cross section of the bypass coolant channel.

12. The drive assembly as claimed in claim 11,
wherein when the bypass valve is open, coolant from the pump flows to the sump via the bypass coolant channel based on the coolant channel cross section of the bypass coolant channel being larger than the coolant channel cross section of the main coolant channel.

13. The drive assembly as claimed in claim 12, wherein a throttle is disposed in the main cooling channel.

14. The drive assembly as claimed in claim 13, wherein the throttle disposed downstream of a branching location of the bypass cooling channel from the main cooling channel.

15. The drive assembly as claimed in claim 14,
wherein the parking lock assembly has a parking lock,
wherein the parking lock and the bypass valve are actuated via the actuator as a unit in three operating positions,
wherein the operating positions include:
a first operating position, in which the parking lock is engaged and the bypass valve is closed,
a second operating position, in which the parking lock is disengaged and the bypass valve is closed, and
a third operating position, in which the parking lock is disengaged and the bypass valve is open.

16. The drive assembly as claimed in claim 11,
wherein the parking lock assembly has a parking lock,
wherein the parking lock and the bypass valve are actuated via the actuator as a unit in three operating positions,
wherein the operating positions include:
a first operating position, in which the parking lock is engaged and the bypass valve is closed,
a second operating position, in which the parking lock is disengaged and the bypass valve is closed, and
a third operating position, in which the parking lock is disengaged and the bypass valve is open.
